(19) United States
(12) Patent Application Publication
(10) Pub. No.: US 2012/0020217 A1
(43) Pub. Date: Jan. 26, 2012

(54) STORING NETWORK FLOW INFORMATION

(76) Inventors: Shaun Wakumoto, Roseville, CA (US); Saugat Majumdar, Roseville, CA (US)

(21) Appl. No.: 13/139,762

(22) PCT Filed: Dec. 30, 2008
(86) PCT No.: PCT/US08/88519

§ 371 Date: Jun. 15, 2011

(51) Int. Cl. H04L 12/56

(52) U.S. Cl. 370/235

(57) ABSTRACT

Storing network flow information. Network packets comprising network internet protocol flow information is received at a network device, the network packets comprising an internet protocol header comprising internet protocol source and destination information pairs. The internet protocol source and destination information pairs are stored at a memory table of the network device. The internet protocol source and destination information pairs are made available for searching.

### FIELD

Embodiments of the present invention relate generally to network computer systems.

### BACKGROUND

Computer systems are commonly networked to other computer systems. Networks can include computer systems, switches, routers and other network devices. In some situations, information, network traffic, and/or network packets sent over a network may damage a computer system or otherwise negatively affect it. It is therefore desirable to track and locate the computer system sending the information, network traffic, and/or network packets. In some situations, the address of a source computer system sending the information, network traffic, and/or network packets is forged or spoofed. This makes it difficult to track the source computer system. Techniques have been developed for tracking and locating such a source computer system with incorrect address information, but such techniques require the source computer system to continuously send information and network traffic or send more than one network packet. Therefore, there is no practical solution for tracking down a source computer system that with incorrect address information.

### SUMMARY

Various embodiments of the present technology, storing network flow information, are described herein. Network packets comprising network protocol flow information is received at a network device, the network packets comprising an internet protocol (IP) header comprising internet protocol source and destination information pairs. The IP source and destination information pairs are stored at a memory table of the network device. The IP source and destination information pairs are made available for searching.

### BRIEF DESCRIPTION OF THE DRAWINGS

FIG. 1 illustrates a block diagram of an example computer network in accordance with embodiments of the present technology.

FIG. 2 illustrates a flowchart of an example method for storing network flow information in accordance with embodiments of the present technology.

FIG. 3 illustrates a flowchart of an example method for storing and tracing network flow information in accordance with embodiments of the present technology.

FIG. 4 illustrates a diagram of an example computer system upon which embodiments of the present technology may be implemented.

FIG. 5 illustrates a table containing network flow information in accordance with embodiments of the present technology.

The drawings referred to in this description of embodiments should be understood as not being drawn to scale except if specifically noted.

### DESCRIPTION OF EMBODIMENTS

Reference will now be made in detail to embodiments of the present technology, examples of which are illustrated in the accompanying drawings. While the technology will be described in conjunction with various embodiment(s), it will be understood that they are not intended to limit the present technology to these embodiments. On the contrary, the present technology is intended to cover alternatives, modifications and equivalents, which may be included within the spirit and scope of the various embodiments as defined by the appended claims.

Furthermore, in the following description of embodiments, numerous specific details are set forth in order to provide a thorough understanding of the present technology. However, the present technology may be practiced without these specific details. In other instances, well known methods, procedures, components, and circuits have not been described in detail as not to unnecessarily obscure aspects of the present embodiments.

Unless specifically stated otherwise as apparent from the following discussions, it is appreciated that throughout the present description of embodiments, discussions utilizing terms such as “receiving”, “storing”, “making available”, “detecting”, “accessing”, “tracing”, “broadening”, or the like, refer to the actions and processes of a computer system, or similar electronic computing device. The computer system or similar electronic computing device manipulates and transforms data represented as physical (electronic) quantities within the computer system's registers and memories into other data similarly represented as physical quantities within the computer system memories or registers or other such information storage, transmission, or display devices. Embodiments of the present technology are also well suited to the use of other computer systems such as, for example, optical and mechanical computers.

### Overview of Discussion

Embodiments of the present technology are for storing and tracing network flow information. For example, network flow information takes place in a network. This network flow information includes network protocol flow which is carried in at least one network packet which includes an interne protocol (IP) header. The IP header of the network packet includes IP source and destination information pairs. The network includes network devices which include a memory table which store the IP source and destination information pairs. The IP source and destination information pairs stored in the memory tables are made available for searching. The IP header of the network packet may also include source and destination port information which may also be stored and made available for searching if available.

In the following embodiments, reference is made to “network packet(s).” This term is to be interpreted as a typical network packet used to send information on a network of computer systems and other hardware devices. It should be appreciated that a network packet includes, but is not limited to, an IP header also known as control information which includes data that is needed to deliver the network packet and also includes user data also known as the payload.

The following discussion will demonstrate various hardware, software, and firmware components that are used with and in network devices and computer systems used for storing and tracing network flow information using various embodiments of the present technology. Furthermore, the network devices, computer systems and their methods may include some, all, or none of the hardware, software, and firmware components discussed below.

### Embodiments of Storing Network Flow Information

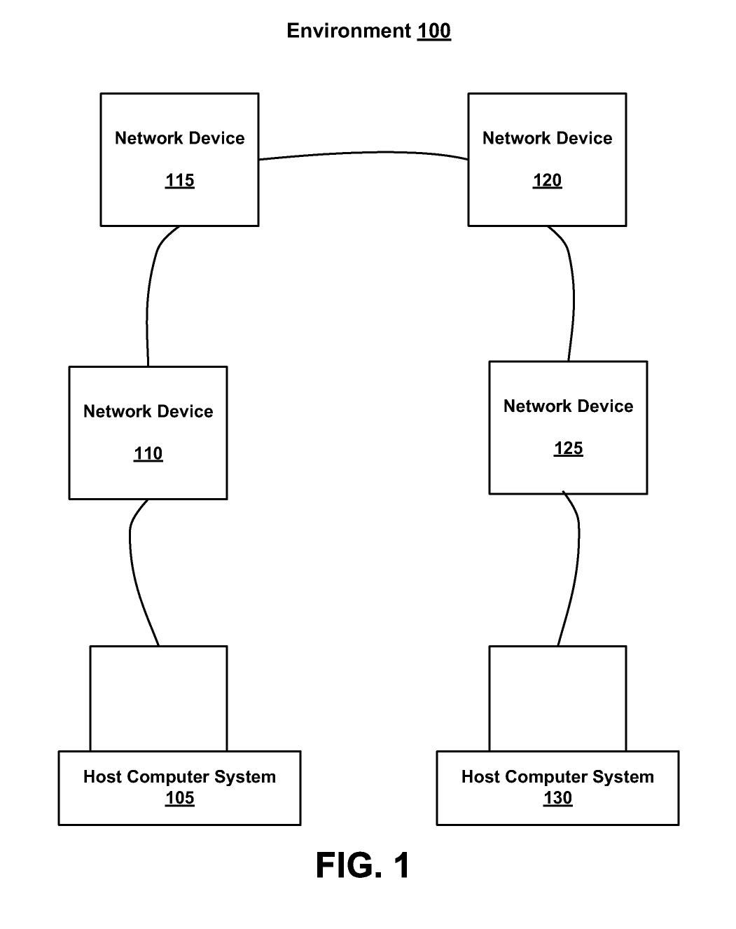

With reference now to FIG. 1, a block diagram of an example environment comprising a network system for storing and tracing network flow information shown in accordance with embodiments of the present technology. Environment 100 includes host computer system 105, network device 110, network device 115, network device 120, network device 125 and host computer system 130. Environment 100 comprises components that may or may not be used with different embodiments of the present technology and should not be construed to limit the present technology. It should be appreciated that the components of environment 100 can be implemented as software, hardware, firmware, or any combination thereof.

FIG. 1 is drawn to depict, in one embodiment, environment 100 with two computer systems; host computer system 105 and host computer system 130. In one embodiment, host computer system 105 sends a network packet with host computer system 130 as the receiver or ultimate destination. In such an embodiment, the network packet is sent to host computer system 130 via network device 110, network device 115, network device 120 and network device 125. It should be appreciated that host computer system 105 can send more than one network packet, but only one network packet need be sent for purposes of the present technology.

In one embodiment, the user of host computer system 130 desires to trace the received network packet to determine which computer system sent the network packet. This task can be complicated if the sender of the network packet has spoofed or forged their address on the network. It should be appreciated that such spoofing or forging can take place intentionally by a malicious user. Additionally, the network packet can include information that causes undesirable or negative results on host computer system 130 which increase the desire to trace the network packet to determine which computer system sent the network packet.

To accomplish the ability to trace the network packet, in one embodiment, network device 110, network device 115, network device 120 and network device 125 are configured to include a hardware memory table. In one embodiment, the hardware memory table is an actually hardware component located in the network device. The hardware memory table has the ability to store information included in the network packet that is sent via the network device of which the memory table is a part of. Specifically, the hardware memory table stores information for the network packet's IP header or control information. In one embodiment, the information stored by the hardware memory table is referred to as network IP flow. It should be appreciated that the hardware memory table can also be included in software or firmware in the network device.

It should be appreciated that network device 110, network device 115, network device 120 and network device 125 can be switches, routers, a component part of a larger computer system or other devices used in a computer network system. Additionally, the network devices depicted in FIG. 1 can also be connected to other network devices not shown in FIG. 1. Furthermore, in one embodiment, a network device includes at the following; a processor, memory which can be random access memory or more permanent memory, and at least one physical port can be an Ethernet port or a universal serial bus port. A network device can be an independent piece of hardware, or it can be a component of a computer system.

In one embodiment, the IP header or control information includes IP source and destination information pairs and may also contain source and destination port information. The IP source and destination information pairs include information identifying the address of the computer system intended to receive the network packet which is the destination and the address of the computer system which sent the network packet which is the source. As stated above, the address of the computer system which sent the network packet can be forged or spoofed. It should be appreciated that the IP source and destination information pairs can be internet protocol (IP) addresses, media access control (MAC) address, virtual local area network (VLAN) addresses and any other network addresses which are intended to identify the source and destination of the network packet. It should be appreciated that source and destination port information can be, but is not limited to, source and destination information for transmission control protocol ports and user datagram protocol ports (TCP/UDP ports).

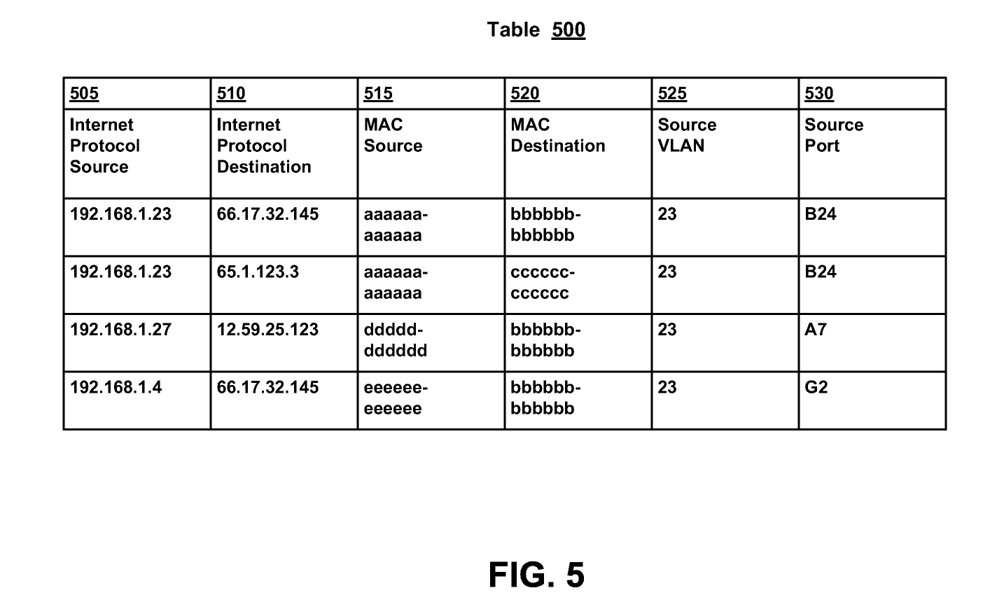

With reference to FIG. 5, table 500 is a table illustrating network flow information comprising IP source and destination information pairs that would be stored in a hardware memory table. Column 505 contains IP source addresses. Column 510 contains IP destination addresses. Column 515 contains MAC source addresses. Column 520 contains MAC destination addresses. Column 525 contains VLAN sources. Column 530 contains source port information. It should be appreciated that table 500 is not limited to the types of data shown therein, it can also contain data pertaining to IP protocol, transmission control protocol (TCP) ports, user datagram protocol (UDP) ports, and other related data.

Referring again to FIG. 1, in one embodiment, the network internet protocol flow stored in the hardware memory table is made available for searching. This searching can be performed to identify the source computer system or sender of the network packet. For example, host computer system 105 sends a network packet to host computer system 130 via network device 110, network device 115, network device 120 and network device 125. Host computer system 130 determines it is desirable to trace the network packet to the source computer system, but upon examining the network packet it is discovered that the source address has been spoofed. In order to trace and locate the source computer system, the hardware memory tables of the network devices are searched.

In this example, network device 125 is first searched because it is directly connected to host computer system 130. The hardware memory table of network device 125 is searched for IP source and destination information pair that is identical to the IP source and destination information pair in the network packet. Once the same IP source and destination information pair is located in network device 125 source port information is also detected and other network devices which are connected to network device 125 are searched for the same source port information. If the source port information is not available, then the IP source and destination information pair will be used for the searching. In this example, the same IP source and destination information pair is traced to network device 120 using the source port information. The searching is then performed for devices connected to network device 120 using source port information found in the memory tables of network device 120. The searching continues in this manner tracing the IP source and destination information pair using the source port information from one network device to the next until the source computer system is discovered. It should be appreciated that source port information is not always available, in such an instance the search may continue using the IP source and destination information pair.

In this example, the source computer system is located even if the source computer system only sent one network packet. The source computer system can also be located even if the source computer system forged or spoof their network address. This is accomplished because the hardware memory tables of the network devices store network IP flow information related to all packets passing through the network devices. It should be appreciated that the hardware memory tables need not store the network IP flow information indefinitely, but need to store the information for an amount of time that would allow the searching to take place once it is desirable to locate a source computer system.

In one embodiment, the described searching will begin by searching edge network devices instead of core network devices. Edge network devices are defined to be network devices which are directly connected to a host computer system as well as at least one other network device. Core network devices are defined to be network devices that are only connected to other network devices. Ideally, the edge network devices will experience less traffic and will therefore have less IP flow information stored in their hardware memory tables. Therefore, the searching is faster because there is less information to search. Additionally, the search is more likely to find the IP source and destination information pair matching the network packet in an edge network device because the network device connected with the destination computer system will be an edge network device.

In one embodiment, not all network devices include a hardware memory table. In such an embodiment, the described searching and tracing cannot take place using network devices that do not include a hardware memory table. In this instance, the search is scalable and is broadened to include network devices that are not directly connected to host computer system 130. For example, if network device 125 did not include a hardware memory table, then the search would be broadened to include network device 120. In a different example, assume that network device 120 does not include a hardware memory table. In this example, the IP source and destination information pair would be traced using the source port information to network device 125. At this point the search would be broadened to include network device 115. If network device 115 did not include a hardware memory table then the search would be broadened to include network device 110. The search can be continue to be broadened in this manner until the IP source and destination information pair is located using the source port information in a network device or the source computer system is located. It should be appreciated that source port information is not always available, in such an instance the search may continue using the IP source and destination information pair.

In one embodiment, the described search is executed by a computer system using a combination of software, programs, firmware, hardware and/or algorithms designed to carry out the search techniques described above. In one embodiment, host computer system 130 is used to carry out the search.

### Operation

More generally, in embodiments in accordance with the present invention, storing and tracing network flow information is utilized to locate a host computer system that is the source or sender of a network packet. Such methods can be implemented as a proactive approach to locating host computer system meaning that the first steps of the method are implemented before it is desirable to trace and locate the host computer system that is the source or sender of a network packet. Additionally, these methods can be used to trace the host computer system when only one network packet is sent.

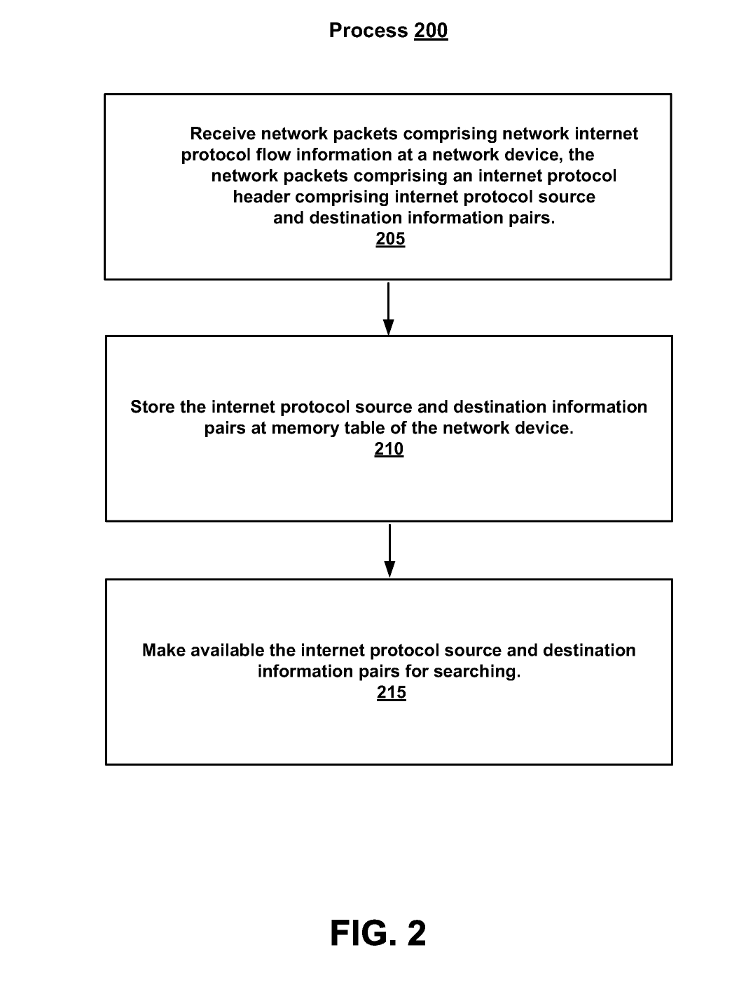

FIG. 2 is a flowchart illustrating process 200 for storing network flow information, in accordance with one embodiment of the present invention. In one embodiment, process 200 is carried out by processors and electrical components under the control of computer readable and computer executable instructions. The computer readable and computer executable instructions reside, for example, in data storage features such as computer usable volatile and non-volatile memory. However, the computer readable and computer executable instructions may reside in any type of computer readable medium. In one embodiment, process 200 is performed by host computer system 130 of FIG. 1.

In one embodiment, process 200 is used to store network flow information. At 205, in one embodiment, network packets comprising network IP flow information are received at a network device, the network packets comprising an IP header comprising IP source and destination information pairs.

At 210, in one embodiment, the IP source and destination information pairs of the network JP flow are stored in the network devices using a memory hardware table. In one embodiment, the memory table is a hardware component of the network devices. It should be appreciated that the memory table can be hardware, software, firmware or any combination thereof.

At 215, in one embodiment, the IP source and destination information pairs of the network IP flow are made available for searching.

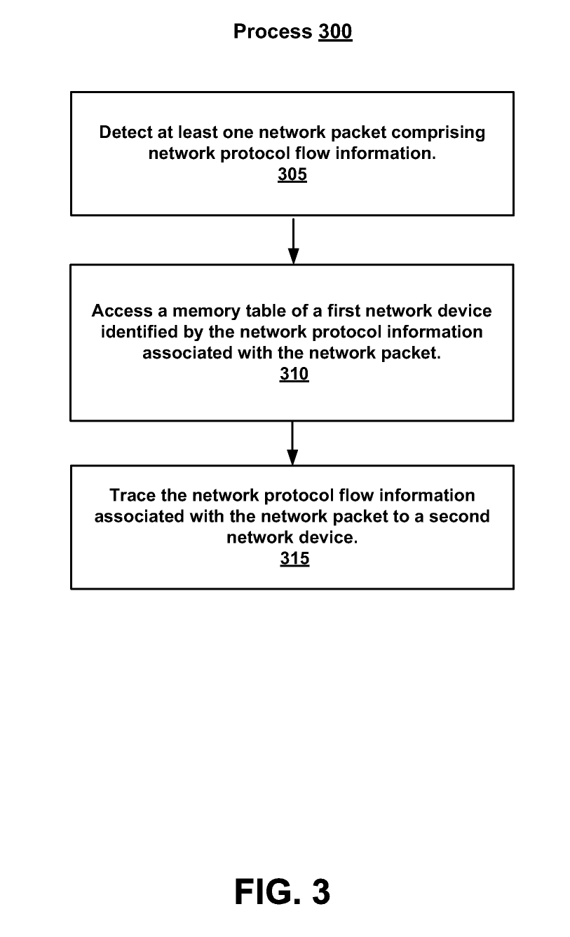

FIG. 3 is a flowchart illustrating process 300 for tracing network flow information, in accordance with one embodiment of the present invention. In one embodiment, process 300 is carried out by processors and electrical components under the control of computer readable and computer executable instructions. The computer readable and computer executable instructions reside, for example, in data storage features such as computer usable volatile and non-volatile memory. However, the computer readable and computer executable instructions may reside in any type of computer readable medium. In one embodiment, process 300 is performed by host computer system 130 of FIG. 1.

In one embodiment, process 300 is used to trace network flow information. At 305, in one embodiment, at least one network packet comprising network protocol flow information is detected.

At 310, in one embodiment, a memory table of a first network device identified by the network protocol information associated with the network packet is accessed. In one embodiment, the memory table is a hardware component of the first network device. It should be appreciated that the memory table can be hardware, software, firmware or any combination thereof.

At 315, in one embodiment, the network protocol flow information associated with the network packet is traced to a second network device.

In one embodiment, step 315 is repeated to trace a third network device. In on embodiment, step 315 is repeated until a host computer system is located that sent the at least one network packet.

In one embodiment, step 315 is carried out to first search edge network devices and then core hardware devices.

In one embodiment, step 315 results in not discovering the second network device. In such an embodiment, the trace can be broadened to include searching memory tables of network devices other than said second network device.

In one embodiment, step 315 is carried out by first searching the network protocol flow information contained in the hardware memory tables of network devices which are directly connected to the computer system. In one embodiment, this search may be broadened to include network devices which are not directly connected to the computer system. In similar embodiments, after the second network device has been discovered, a third network device may be searched for. In such an embodiment, network devices directed connected to the second network device may be searched or the search may be broadened to include network devices not directly connected to the second network device.

### Example Computer System Environment

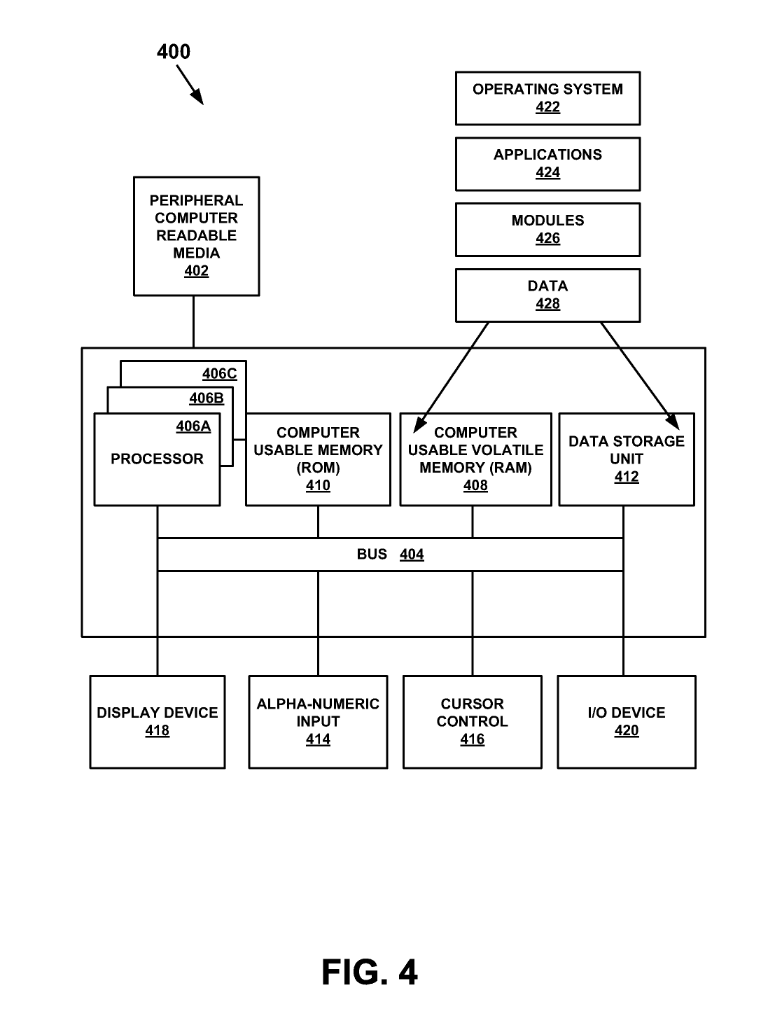

With reference now to FIG. 4, portions of embodiments of the technology for providing a communication composed of computer-readable and computer-executable instructions that reside, for example, in computer-usable media of a computer system. That is, FIG. 4 illustrates one example of a type of computer that can be used to implement embodiments of the present technology.

FIG. 4 illustrates an example computer system 400 used in accordance with embodiments of the present technology. It is appreciated that system 400 of FIG. 4 is an example only and that embodiments of the present technology can operate on or within a number of different computer systems including general purpose networked computer systems, embedded computer systems, routers, switches, server devices, user devices, various intermediate devices/artifacts, stand alone computer systems, mobile phones, personal data assistants, and the like. As shown in FIG. 4, computer system 400 of FIG. 4 is well adapted to having peripheral computer readable media 402 such as, for example, a floppy disk, a compact disc, and the like coupled thereto.

System 400 of FIG. 4 includes an address/data bus 404 for communicating information, and a processor 406A coupled to bus 404 for processing information and instructions. As depicted in FIG. 4, system 400 is also well suited to a multi-processor environment in which a plurality of processors 406A, 406B, and 406C are present. Conversely, system 400 is also well suited to having a single processor such as, for example, processor 406A. Processors 406A, 406B, and 406C may be any of various types of microprocessors. System 400 also includes data storage features such as a computer usable volatile memory 408, e.g. random access memory (RAM), coupled to bus 404 for storing information and instructions for processors 406A, 406B, and 406C.

System 400 also includes computer usable non-volatile memory 410, e.g. read only memory (ROM), coupled to bus 404 for storing static information and instructions for processors 406A, 406B, and 406C. Also present in system 400 is a data storage unit 412 (e.g., a magnetic or optical disk and disk drive) coupled to bus 404 for storing information and instructions. System 400 also includes an optional alpha-numeric input device 414 including alphanumeric and function keys coupled to bus 404 for communicating information and command selections to processor 406A or processors 406A, 406B, and 406C. System 400 also includes an optional cursor control device 416 coupled to bus 404 for communicating user input information and command selections to processor 406A or processors 406A, 406B, and 406C. System 400 of the present embodiment also includes an optional display device 418 coupled to bus 404 for displaying information.

Referring still to FIG. 4, optional display device 418 of FIG. 4 may be a liquid crystal device, cathode ray tube, plasma display device or other display device suitable for creating graphic images and alpha-numeric characters recognizable to a user. Optional cursor control device 416 allows the computer user to dynamically signal the movement of a visible symbol (cursor) on a display screen of display device 418. Many implementations of cursor control device 416 are known in the art including a trackball, mouse, touch pad, joystick or special keys on alpha-numeric input device 414 capable of signaling movement of a given direction or manner of displacement. Alternatively, it will be appreciated that a cursor can be directed and/or activated via input from alpha-numeric input device 414 using special keys and key sequence commands.

System 400 is also well suited to having a cursor directed by other means such as, for example, voice commands. System 400 also includes an I/O device 420 for coupling system 400 with external entities. For example, in one embodiment, I/O device 420 is a modem for enabling wired or wireless communications between system 400 and an external network such as, but not limited to, the Internet.

Referring still to FIG. 4, various other components are depicted for system 400. Specifically, when present, an operating system 422, applications 424, modules 426, and data 428 are shown as typically residing in one or some combination of computer usable volatile memory 408, e.g. random access memory (RAM), and data storage unit 412. However, it is appreciated that in some embodiments, operating system 422 may be stored in other locations such as on a network or on a flash drive; and that further, operating system 422 may be accessed from a remote location via, for example, a coupling to the internet. In one embodiment, the present technology, for example, is stored as an application 424 or module 426 in memory locations within RAM 408 and memory areas within data storage unit 412. Embodiments of the present technology may be applied to one or more elements of described system 400. For example, a method of modifying user interface 225A of device 115A may be applied to operating system 422, applications 424, modules 426, and/or data 428.

The computing system 400 is only one example of a suitable computing environment and is not intended to suggest any limitation as to the scope of use or functionality of the present technology. Neither should the computing environment 400 be interpreted as having any dependency or requirement relating to any one or combination of components illustrated in the example computing system 400.

Embodiments of the present technology may be described in the general context of computer-executable instructions, such as program modules, being executed by a computer. Generally, program modules include routines, programs, objects, components, data structures, etc., that perform particular tasks or implement particular abstract data types. Embodiments of the present technology may also be practiced in distributed computing environments where tasks are performed by remote processing devices that are linked through a communications network. In a distributed computing environment, program modules may be located in both local and remote computer-storage media including memory-storage devices.

Although the subject matter is described in a language specific to structural features and/or methodological acts, it is to be understood that the subject matter defined in the appended claims is not necessarily limited to the specific features or acts described above. Rather, the specific features and acts described above are disclosed as example forms of implementing the claims.

1. A method for storing network flow information, said method comprising:
receiving network packets comprising network internet protocol flow information at a network device, said network packets comprising an internet protocol header comprising internet protocol source and destination information pairs;
storing said internet protocol flow information comprising said internet protocol source and destination information pairs at a memory table of said network device; and
making available said internet protocol flow information comprising said internet protocol source and destination information pairs for searching.

2. The method of claim 1 wherein said internet protocol source and destination information pairs are internet protocol addresses comprising source and destination addresses.

3. The method of claim 1 wherein said internet protocol source and destination information pairs are media access control (MAC) addresses comprising source and destination addresses.

4. The method of claim 1 wherein said internet protocol flow information further comprises source and destination port information, said storing said internet protocol flow information further comprises storing said source and destination port information, and said making available said internet protocol flow information for searching further comprises making available said source and destination port information for searching.

5. The method of claim 1 wherein said memory table is a component hardware memory table of said network device.

6. The method of claim 1 wherein said internet protocol source and destination information pairs of said network packets comprises source information that incorrectly identifies a source of said network packets.

7. A network device for storing network flow information, said device comprising:
a processor;
a memory;
a physical port for receiving a network packet comprising network flow information, said network packet comprising an internet protocol header comprising internet protocol source and destination information pairs; and
a hardware memory table configured to store and make available for searching said internet protocol source and destination information pairs.

8. The device of claim 7 wherein said network device is a network switch.

9. The device of claim 7 wherein said internet protocol header further comprises source and destination port information and said hardware memory table is further configured to store and make available for searching said source and destination port information.

10. The device of claim 7 wherein said internet protocol source and destination information pairs are virtual local area network (VLAN) addresses including source and destination addresses.

11. A method for tracing network flow information, said method comprising:
detecting at least one network packet comprising an internet protocol header comprising network protocol flow information;
accessing a memory table of a first network device identified by said network protocol flow information associated with said network packet; and
tracing said network protocol flow information associated with said network packet to a second network device.

12. The method of claim 11 wherein said network protocol flow information comprises internet protocol source and destination addresses.

13. The method of claim 11 wherein said network protocol flow information comprises source and destination port information.

14. The method of claim 11 wherein said tracing comprises first searching edge network devices and then searching core network devices.

15. The method of claim 11 wherein said memory table of said network device is a component hardware device of said network device.
